(19) United States
(12) Patent Application Publication
(10) Pub. No.: US 2017/0225106 A1
(43) Pub. Date: Aug. 10, 2017

(54) REUSABLE FILTER AND CLEANING SYSTEM

(71) Applicants: Michael Gurnicz, Murrrells Inlet, SC (US); Michael Long, Concord, NC (US); Brad Long, Clemmons, NC (US)

(72) Inventors: Michael Gurnicz, Murrrells Inlet, SC (US); Michael Long, Concord, NC (US); Brad Long, Clemmons, NC (US)

(21) Appl. No.: 15/396,958

(22) Filed: Jan. 3, 2017

Related U.S. Application Data
(60) Provisional application No. 62/291,105, filed on Feb. 4, 2016.

(51) Int. Cl. B01D 41/04; B08B 3/04; B08B 3/12

(52) U.S. Cl. CPC B01D 41/04; B08B 3/12; B08B 3/04

(57) ABSTRACT

A filter and filter cleaning system wherein the filter is reusable after ultrasonic cleaning in a tank. The filter is disassembled, separating the filter element from the case. The filter element comprises a micromesh metallic filter core that traps contaminants within it during normal use. The micromesh core element is cleaned in a liquid bath while being exposed to ultrasonic vibrations that shake the contaminants from the mesh filter structure. The contaminants are washed from the mesh by the fluid bath as they are separated from the mesh structure. Once cleaned, the filter is reassembled and can be reused unlike typical paper care filters that must be discarded.

This application claims priority from a provisional application, No. 62/291,105, filed Feb. 4, 2016.

### FIELD OF THE INVENTION

The invention pertains to the field of filters and filter cleaning systems, and particularly to combustion engine filters that can be cleaned for reuse.

### BACKGROUND OF THE INVENTION

Caring for the environment has become a virtually universal goal for all industries and especially for those that regularly create a considerable quantity of waste products that challenge the environment. The present invention does its part to help ameliorate environmental concerns while offering industries, particularly those that operate fleet vehicle businesses, the opportunity to both lessen the environmental burden that their operations cause and save money.

present invention combines a filter, most commonly though not exclusively a vehicular oil filter, having a micromesh metallic filter element with a cleaning apparatus that subjects the filter element to ultrasonic waves to clean it. Once cleaned, the filter element is reassembled into the filter casing to be reused rather than discarded, as is the present practice with ordinary paper-core oil filters. The invention simultaneously provides significant cost containment by making the filters reusable rather than disposable, and lessens the environmental impact of millions of discarded, contaminated filters.

### SUMMARY OF THE INVENTION

A reusable filter cleaning system that comprises in combination a reusable filter and an ultrasonic filter cleaning apparatus, the filter comprising a case and a removable, cleanable and reusable filter element, and the cleaning apparatus comprising a dual well fluid tank and an ultrasonic wave generator adjacent to one fluid well of said tank that generates ultrasonic wave energy into the said fluid well. The reusable filter element comprises a micromesh material that may be metallic. The metallic material may be stainless steel.

The system further comprises a cleaning solvent in at least one well of the fluid tank. The ultrasonic wave generator produces dynamic frequency sweep ultrasonic energy waves. The ultrasonic generator comprises modular transducers. The system further comprises absorbent pads placed on the surface of the cleaning solvent for absorbing oil products suspended in the cleaning solvent.

### BRIEF DESCRIPTION OF THE DRAWINGS

For purposes of illustrating the invention, the drawings show one or more forms in which the invention can be embodied. The invention is not, however, limited to the precise forms shown unless such limitation is expressly made in a claim.

FIG. 1 is a functional block diagram of the system of the invention.

FIG. 2 is a composite side elevation view and top plan view of a filter canister with its top removed.

FIG. 3 is a composite of a side view and a top perspective view of a generalized representation of the micromesh filter element.

FIG. 4a is a partial top detail view of a pleated micromesh filter element in place.

FIG. 4b is a partial perspective view of a pleated micromesh filter element.

FIG. 5a is a schematic view of the composite parts of a sintered metallic mesh filter material.

FIG. 5b is an exploded view of a multilayer sintered metallic mesh filter material and a schematic view of the resulting filter material.

FIG. 6 presents three schematic views of a sintered metallic mesh filter material.

FIG. 7 is a perspective view of the ultrasonic cleaning tank.

FIG. 8 is a perspective view of the ultrasonic cleaning tank and absorbent pads.

### DETAILED DESCRIPTION

Herein described is a system providing a reusable filter together with an ultrasonic cleaning apparatus. The filter described herein as an example application is a vehicular oil filter, although this embodiment may not be the exclusive application of the reusable filter of the invention. The filter comprises a micromesh metallic filter element inside a canister rather than a paper, or other one-time use, filter element. The micromesh filter element entraps finer contaminant particles than paper filters typically remove from engine oil.

The system also comprises a cleaning apparatus that provides for mounting the filter element in a cleaning solution wherein said filter is subjected to ultrasonic wave vibration. The ultrasonic exposure shakes contaminants loose from the filter mesh as the cleaning solution circulates within the apparatus. The ultrasonic waves create millions of tiny bubbles that implode as they circulate within the filter element, dislodging debris from even the smallest crevices in the mesh. The process is cavitation and the circulating solution carries away the debris that cavitation shakes loose from the filter element. This leaves the filter element clean and ready for reassembly into the canister to be reused in its entirety.

This process of cleaning and reusing the filter is repeated at each oil change, eliminating the problem of disposal of millions of traditional paper element oil filters in the vehicular example. Because the micromesh filter core is accessible and removable it can be removed and cleaned as needed to extend the life of the filter for years. Reuse eliminates the necessity of disposing of used paper filters that normally are impregnated with up to 45 percent of their weight representing toxic used oil and heavy metal contaminants.

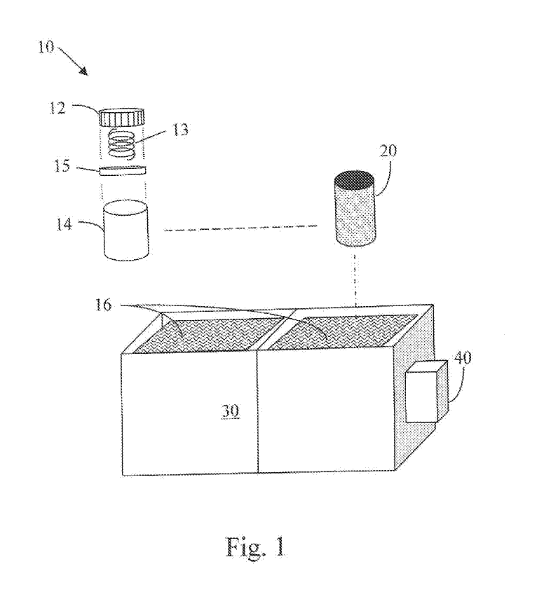

Referring to FIG. 1, the system comprises a filter 10 that is a combination of a filter case 14 having a micromesh filter element 20 contained within it. Commonly the filter 10 comprises a cylindrical case 14 and a removable cap 12. The filter 10 further comprises a sealing gasket 15 and an elastomer seat (not shown) at the bottom of the case 14. A spring 13 is compressed between the cap 12 and the filter element 20 to hold the filter element 20 in place within the case 14. The filter element 20 can be removed for cleanining by removing the cap 12, spring 13 and gasket 15 and extracting the filter element 20.

The system further comprises a cleaning tank 30 that normally has two liquid wells that contain a cleaning fluid 16. An ultrasonic generator 40 is affixed to the cleaning tank 30. The ultrasonic generator 40 produces ultrasonic vibrations that pass into the cleaning fluid 16 to literally shake contaminating particulates from the filter element 20 that is submerged in the cleaning fluid 16.

Referring to FIG. 2, the filter 10 typically comprises a cylindrical case 14, a gasket 15, a spring 13 and a cap 12. The cap 12 comprises a plurality of ports 18 that permit the entry and exit of the fluid, which in the described example is engine oil, that is cleaned by the micromesh filter element 20.

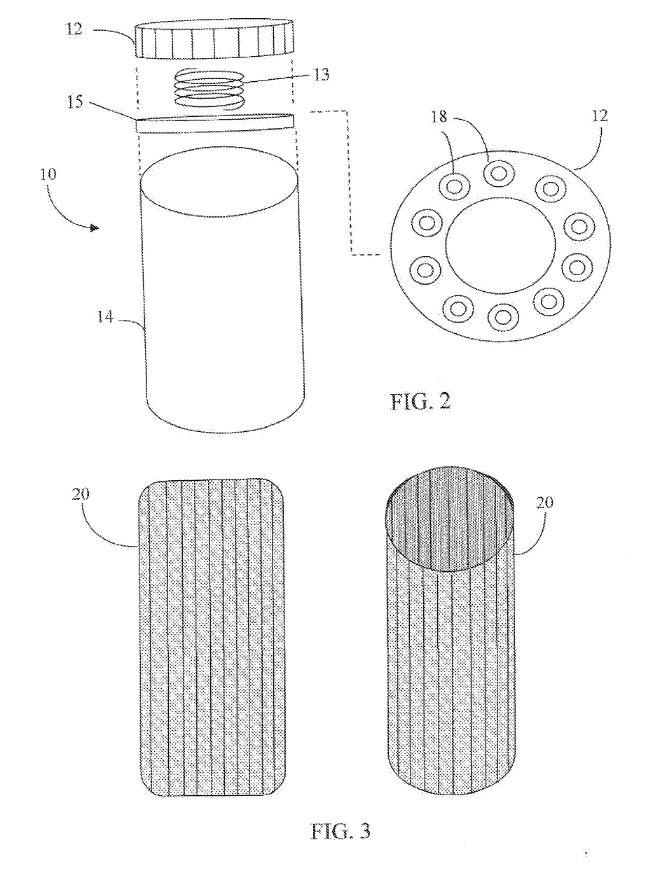

FIG. 3 illustrates two representations of the micromesh filter element 20. The illustration on the left is a side elevation view of the normally (though not necessarily) cylindrical filter element 20 shown in the right view of FIG. 3 in perspective. The micromesh material of the filter element may be a microns-thin stainless steel for long life and durability though other corrosion resistant metals may be employed. The stainless steel mesh has thousands of tiny micron apertures for fluid to circulate through the mesh, trapping contaminants in the mesh. Micron apertures of between 10 and 50 microns are generally employed.

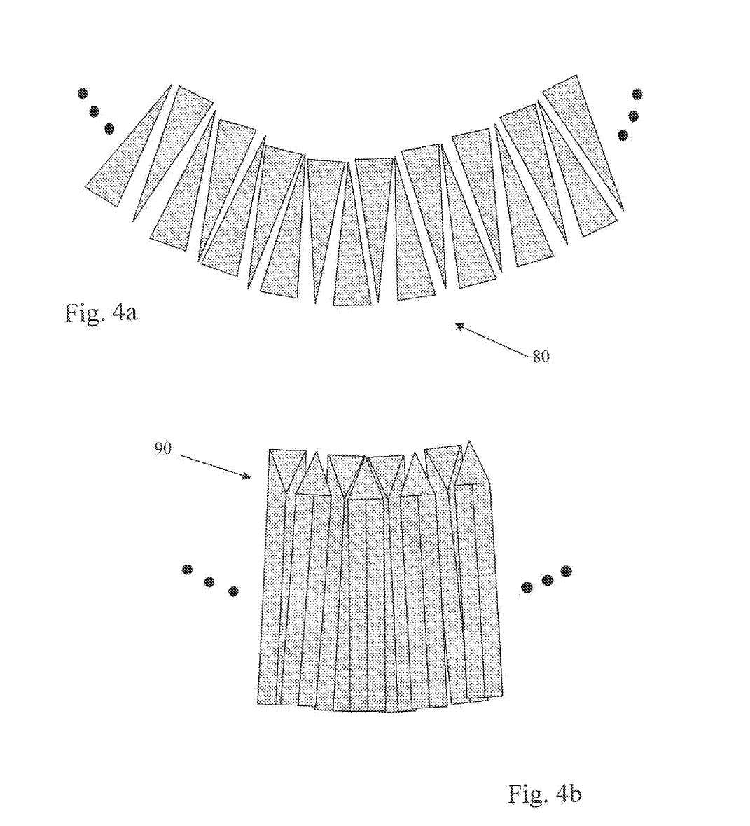

The actual configuration of the cylindrical micromesh filter element may be in the form of a pleated gathering of the mesh sheet material as illustrated in FIGS. 4a and 4b. The micromesh material may start as a flat sheet of metal having thousands of micron-sized holes. The material is folded accordion style into a cylinder of overlapping segments. FIG. 4a is a partial top view of the folded micromesh sheet 80 shaped to fit within a cylindrical filter casing. FIG. 4b is a partial side elevation of the mieromesh sheet 90 illustrating the large number of micron apertures in the micromesh material folded into an accordion-type gathering within the filter. The thousands of micron apertures trap particulates in the mesh to keep the fluid, e.g., engine oil, as free of potentially damaging contaminants as possible.

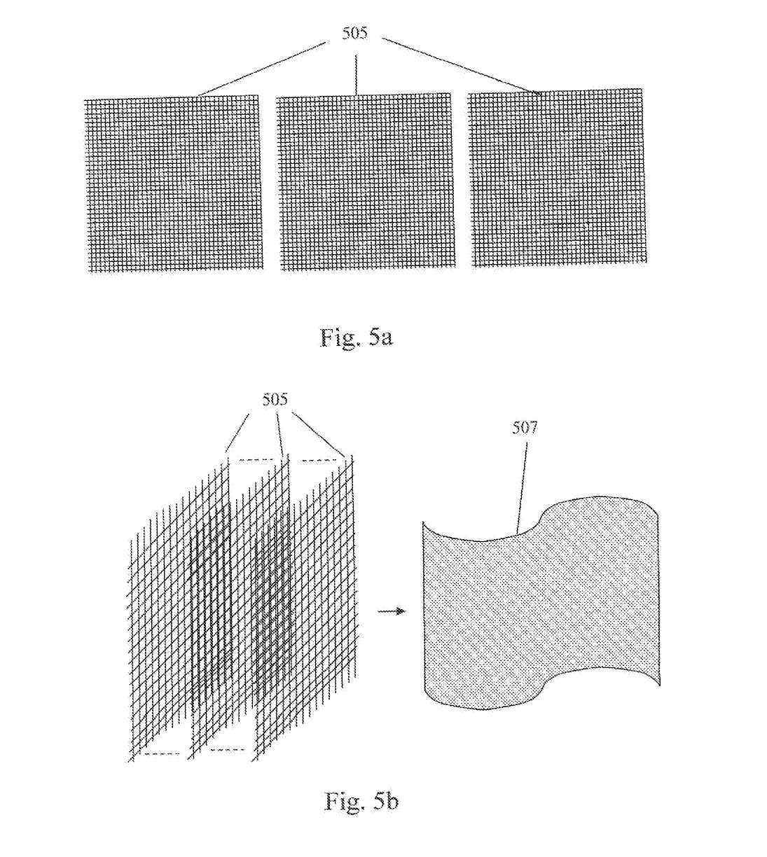

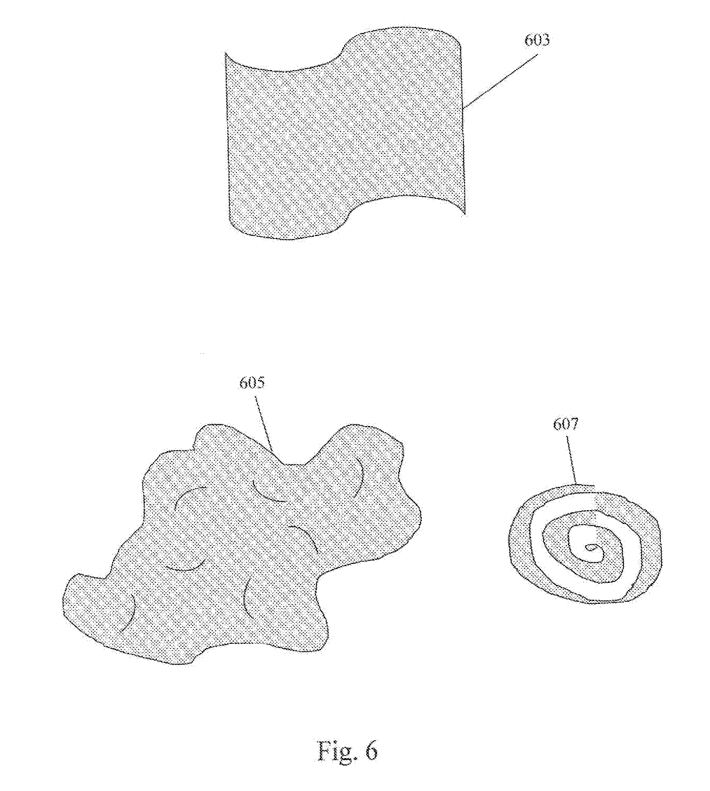

In some cases the filter element may further comprise a second component along with the pleated mesh. A porous sheet of metallic material resembling cloth may be incorporated into the filter element. Referring to FIG. 5, this material is a sintered mesh comprised of layered, flexible metallic sheet that acts much like a paper filter element. FIG. 5a depicts as an example three sheets of fine screen mesh 505 having very small apertures. FIG. 5b illustrates the assembly of these sheets 505 into a multilayered cloth-like material 507 by sintering them together. FIG. 6 shows a sheet of the sintered mesh material 603 which can be formed into a crumpled mass 605 or rolled into a cylinder shape 607 for placement within a filter case.

The fluid passes through the sintered mesh under pressure leaving contaminant particles trapped in the sintered mesh. Being metallic, the sintered mesh is also cleanable along with the pleated metallic mesh when subjected to ultrasonic vibration. The inclusion of a sintered mesh structure into the filter element with the pleated micromesh structure causes the fluid to pass through the filter in a “tortured path” intended to remove as many contaminant particles as possible in each journey through the filter. Together with the micromesh filter element 20, this two-stage metallic filter is very effective in removing particulates from the circulating fluid, as in the example of vehicular oil.

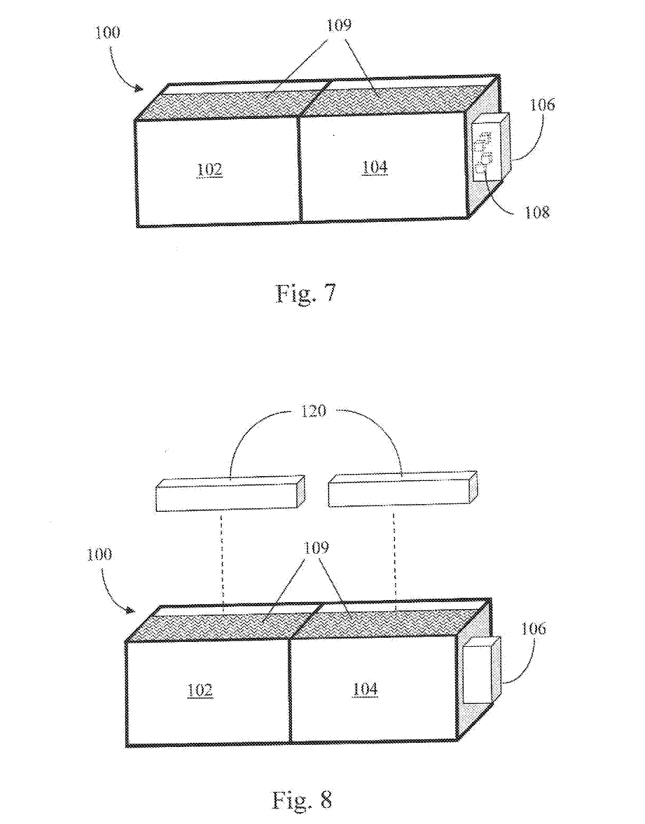

The filter material is micromesh metal rather than paper (as in most automobile oil filters) so that the filter may be removed, cleaned, and reused repeatedly. The cleaning apparatus is illustrated in FIG. 7. The cleaning apparatus comprises a fluid tank 100 with two fluid wells 102, 104. The cleaning tank 104 contains a small amount of environmentally safe detergent to facilitate cleaning, and the second tank 102 contains water to facilitate a final rinse of the filter core.

Attached to the side of one fluid well is an ultrasonic vibration generator 106. The ultrasonic generator 106 creates ultrasonic vibrations that are transmitted into the cleaning fluid well 104 adjacent to the generator. A small rack (not shown) may be placed into the well 104 to support one or more filter elements in the cleaning solvent 109 during cleaning.

The ultrasonic generator 106 comprises modular transducers 108 which are the elements that produce the ultrasonic sound waves within the ultrasonic generator 106. These transducers 108 provide a dynamic frequency sweep that modulates the ultrasonic sound waves through a predetermined frequency range. This frequency modulation vibrates the filter element in a variable manner such that the entrapped contaminants, which might not be shaken loose at a single frequency, are exposed to a constantly changing frequency of vibration pattern. The modular transducers 108 are also removable and replaceable in the event that they fail or require maintenance.

An example description of the cleaning process for a vehicular filter follows. A filter that has been in use for a prescribed period is removed from the engine. The filter is drained of used oil. The cap is removed from the filter case (see FIG. 1) and the filter element (or “core”) is removed and again allowed to drain. Once the filter core is drained, the filter case and core are placed separately into the cleaning tank in the fluid well adjacent the ultrasonic generator. The cleaning tank fluid well contains a cleaning solvent that is typically warmed to approximately 170° F. before operation.

The filter case and core should be cleaned by exposure to ultrasonic vibration for at least ten minutes. After cleaning, the filter core and case should be swirled in the cleaning solution in the second fluid well of the cleaning tank for a brief period to rinse off any loose particulates. The case and core are placed on a draining surface while the cleaning solution flows away. Once drained, the case and core should be exposed to forced air from the top down to blow residual moisture from the filter components. The filter components should be stored in a clean environment for about twenty-four hours before they are re-installed on an engine. The filter case, cap, and filter element are reassembled in the reverse order of their disassembly. The reusable filter with a metallic filter core has a functional period of over five years compared with the several months lifetime of a common paper filter.

After several filters have been cleaned, the cleaning solvent 109 in both fluid wells 102, 104 of the tank 100 has used oil, particulates, and contaminants suspended in the solvent. Heavier particulates will settle to the bottom of the wells. Rather than replacing the solvent after each cleaning cycle, the oil products can be removed from the solvent by placing absorbent pads 120 onto the surface of the solvent 109 in each fluid well 102, 104 of the tank 100 as shown in FIG. 8. In a period of hours (typically overnight) the absorbent pads 120 soak up the oil products leaving the cleaning solvent ready for use again.

Configurations of the invention that vary in some detail from the described embodiment are possible. Therefore, reference to the following claims is necessary to understand the scope and limits of the invention.

What is claimed is:

1. A reusable filter cleaning system comprising in combination:
a reusable filter and an ultrasonic filter cleaning apparatus,
said filter comprising a case and a removable, cleanable and reusable filter element; and
said cleaning apparatus comprising a fluid tank having at lease one fluid well and an ultrasonic wave generator adjacent to the at least one fluid well of said tank that generates ultrasonic wave energy into the said fluid well.

2. The reusable filter cleaning system of claim 1 in which the reusable filter element comprises a micromesh material.

3. The reusable filter cleaning system of claim 3 in which the micromesh material of the filter element is a metallic mesh sheet.

4. The reusable filter cleaning system of claim 3 in which the metallic mesh comprises a stainless steel sheet.

5. The reusable filter cleaning system of claim 3 in which the metallic mesh is formed into a pleated cylindrical filter element within the filter case.

6. The reusable filter cleaning system of claim 3 in which said filter element further comprises a metallic sintered mesh filter material.

7. The reusable filter cleaning system of claim 1 further comprising a cleaning solvent in the at least one well of the fluid tank.

8. The reusable filter cleaning system of claim 6 further comprising a second well in the fluid tank.

9. The reusable filter cleaning system of claim 7 wherein the second well contains a cleaning solvent.

10. The reusable filter cleaning system of claim 1 in which the ultrasonic wave generator produces dynamic frequency sweep ultrasonic energy waves into the at least one well of the fluid tank.

11. The reusable filter cleaning system of claim 1 in which the ultrasonic generator comprises modular transducers.

12. The reusable filter cleaning system of claim 9 further comprising absorbent pads placed on the cleaning solvent for absorbing oil products suspended in the cleaning solvent.
